(19) United States
(12) Patent Application Publication
(10) Pub. No.: US 2013/0024345 A1
(43) Pub. Date: Jan. 24, 2013

(54) Interest Accrual Provisions For Multi-Laterally Traded Contracts

(71) Applicants: Richard Co, Chicago, IL (US); Steven A. Youngren, Elgin, IL (US); Lori Aldinger, Naperville, IL (US); John Labuszewski, Westmont, IL (US)

(72) Inventors: Richard Co, Chicago, IL (US); Steven A. Youngren, Elgin, IL (US); Lori Aldinger, Naperville, IL (US); John Labuszewski, Westmont, IL (US)

(73) Assignee: CHICAGO MERCANTILE EXCHANGE INC., Chicago, IL (US)

(21) Appl. No.: 13/187,837

(22) Filed: Jul. 21, 2011

(51) Int. Cl. G06Q 40/00

(52) U.S. Cl. 705/37

(57) ABSTRACT

In the context of multi-laterally traded contracts, a method may be invoked in the event that payments denominated in a particular currency that are required in satisfaction of the contractual obligations of the contract cannot be made. Payments may be deferred for a specified number of business days or until such time as commercially practicable. Unpaid payments due may accrue interest and/or penalties at rates as determined by a governing body.

### STATEMENT OF RELATED APPLICATION

This application is related to commonly-owned U.S. application Ser. No. TBD, filed the same day herewith, entitled, “Modification of Multi-Laterally Traded Contracts Based on Currency Unavailability Condition,” having attorney docket number 006119.00237 and initially naming the same inventors, the disclosure of which is hereby incorporated by reference in its entirety.

### BACKGROUND

Current futures contracts operating within a multi-lateral trading and clearing environment provide for daily mark-to-market (MTM) payments and a final payment based on the final mark of a cash-settled contract, or, the payment of an invoice amount in satisfaction of the delivery of a particular financial instrument, commodity, currency, etc. These payments are made in a particular designated currency that is specified by the contract. Although exchange rates of various currencies relative to one another may fluctuate, conventional futures contracts typically assume the unrestricted availability of a specified currency on commercially reasonable terms.

It is understood that such payments are unimpeded by considerations including illiquidity in the currency market, possible inconvertibility of such currency, or non-transferability of such currency. However, there are situations where a futures exchange may wish to provide for payments in currencies where such risks exist, e.g., in Chinese renminbi (RMB). Currently, futures contracts do not provide for solutions to these possible problems apart from the possibility of taking emergency actions on an ad hoc basis. However, exchanges seek to avoid taking emergency or ad hoc actions for a number of reasons including a regulatory requirement for extraordinary reporting of such actions and the fact that such actions may undermine confidence in a particular marketplace. It is preferable to anticipate possible circumstances that might impede the normal operation of a publically traded contract and provide for pre-programmed solutions.

A need exists in the context of multi-laterally traded and cleared futures markets. Solutions have been applied in the context of over-the-counter (OTC) derivatives markets that are traded and carried on a bi-lateral basis; however, there is a qualitative difference between applying such contingencies on a bi-lateral versus a multi-lateral basis. Specifically, it is relatively easy to reach an accommodation between two counterparties, but a futures contract must take into account the needs of a number of market participants.

### SUMMARY

In light of the foregoing background, the following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. The following summary merely presents some concepts of the present disclosure in a simplified form as a prelude to the more detailed description provided below.

Aspects of the present disclosure relate to a system and method for trading futures contracts where payments may be due denominated in a currency that might become illiquid, inconvertible, or non-transferable. Aspects of the present disclosure allow for deferral of payments, while incurring interest, for a specified number of business days or until such time as commercially practicable. Unpaid payments due could accrue interest and penalties at rates as determined by a governing body, such as the Chicago Mercantile Exchange.

Aspects of the present disclosure may be provided in a non-transitory computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is a block diagram of a system, according to some embodiments, for use in determining whether unavailability of a particular currency exists.

FIGS. 3 and 4 illustrate methods, according to some embodiments, in which an unavailability of a particular currency is found to exist and in which action is taken as a result.

FIG. 5 illustrates a method, according to some embodiments, that may be performed in connection with a futures contract or other multi-laterally traded and/or cleared contract that designates an interest and/or penalty payment in response to a particular currency being unavailable.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made. Embodiments of the present invention may take physical form in certain parts and steps, examples of which will be described in detail in the following description and illustrated in the accompanying drawings that form a part hereof.

Various aspects described herein may be embodied as a method, a data processing system, and/or a computer program product. Accordingly, those aspects may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of tangible and/or non-transitory computer readable storage media such as hard disks, CD-ROMs, optical storage devices, magnetic storage devices, and/or any combination thereof.

Aspects of the method steps disclosed herein may be executed on one or more processors associated with an exchange computer system 100. Such processors may execute computer-executable instructions stored on non-transitory computer-readable media. The disclosure may also be practiced in distributed computing environments where tasks are performed by remote processing devices that are linked through a communications network. In a distributed computing environment, program modules may be located in both local and remote computer storage media including memory storage devices.

### Exemplary Operating Environment

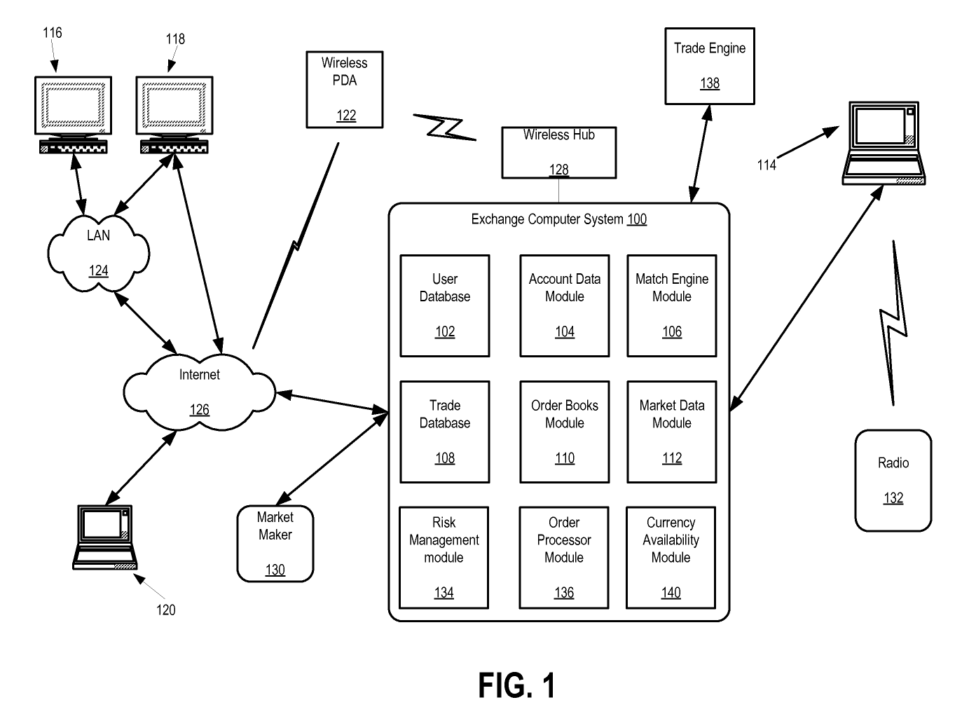

Aspects of at least some embodiments may be implemented with computer devices and computer networks that allow users to exchange trading information. An exemplary trading network environment for implementing trading systems and methods is shown in FIG. 1.

An exchange computer system 100 receives orders and transmits market data related to orders and trades to users. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price.

An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106. A currency unavailability module 140 may be included within exchange computer system 100 for determining whether certain conditions exist with regard to a currency designated for use in satisfying obligations under a particular futures contract type and for taking appropriate action in under those conditions. Those conditions and actions are discussed in more detail below.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

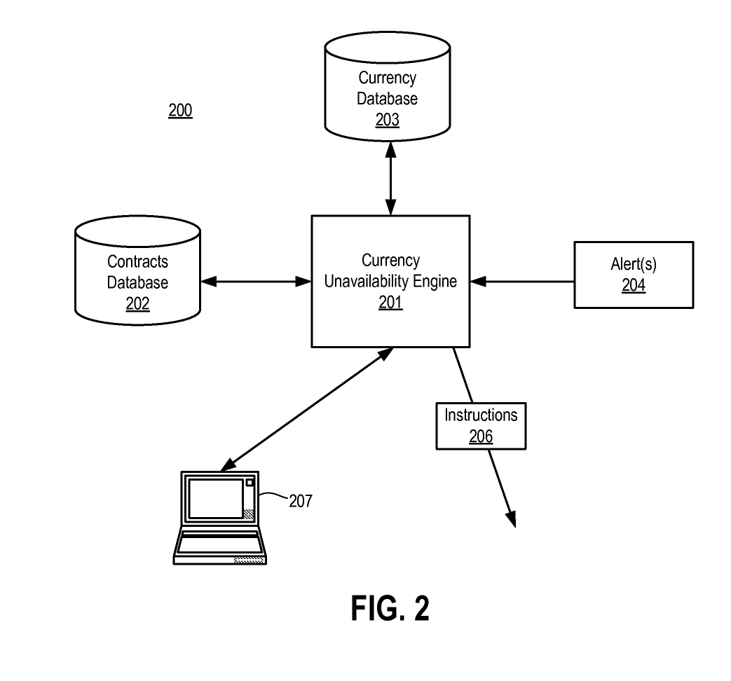

FIG. 2 is a block diagram of a system 200, according to some embodiments, which is configured to determine whether one or more currencies are unavailable and to take certain actions under such conditions. System 200 can be implemented as (or as part of) currency unavailability module 140 (FIG. 1), may be implemented as a standalone system, or may be implemented as part of another system. Currency unavailability engine 201, which may be implemented in the form of one or more microprocessors executing program instructions, interfaces with one or more futures contracts databases 202. Database 202 maintains information regarding various types of futures contracts. For each of multiple futures contract types, that data includes a particular currency and a payment penalty. A particular currency is a currency designated for use in satisfying obligations under contracts of a particular type. A payment penalty is designated for use in satisfying contract obligations if certain currency unavailability conditions are determined to exist.

Unavailability engine 201 receives various types of data from contracts database 202. As to each of at least some of the contract types for which information is maintained in database 202, engine 201 receives initialization data that includes general contract terms (e.g., commodity, currency or other contract subject matter, contract amount, delivery date, particular currency, payment penalty, etc.). Engine 201 also receives information that identifies that amount of contracts of a particular type that are outstanding. Engine 201 may receive updates from database 202 regarding outstanding contracts on a periodic or other basis. Database 202 may be implemented as a distributed database residing in one or more of the modules of exchange computer system 100 (FIG. 1), may be implemented as one or more software routines configured to extract data from one or more of said modules, may be implemented as a standalone database accessible over the Internet or other wide area network, or may be implemented in other ways.

Currency unavailability engine 201 also interfaces with one or more currency databases 203. Database 203 stores information regarding the unavailability of various types of currencies. This information can be compiled using feeds (not shown) from various governmental and financial institutions regarding the quantities of various currency types that are available, interest rates at which currencies may be borrowed, exchange rates of various currencies, short- and long-term historical data regarding availabilities and exchange rates for various currencies, etc. As with contract database 202, currency database 203 can be implemented in various ways.

Engine 201 may also receive alerts 204 that include data regarding availability of one or more types of currencies. Alerts 204 may come from any of multiple sources and may contain any of various types of information regarding potential unavailability of a particular currency. As but one example, an alert 204 could be a communication from third party advising of difficulty in obtaining a particular currency. As another example, an alert 204 could be a communication from a bank or governmental entity advising of limits on currency availability or of changes in currency exchange rates or in interest rates. As a further example, an alert 204 could be automatically transmitted from database 203 based on information accumulated from multiple sources.

Engine 201 outputs instructions 206 that modify the manner in which obligations under futures contracts are satisfied. As explained in more detail below, such instructions can include an instruction that obligations under a contract of a particular type should be satisfied after a period of deferment of a contractual payment while accruing interest and/or penalties for the failure to timely meet the contractual payment.

Engine 201 also may receive other types of input via one or more computers 207. For example, a human user of computer 207 may provide input to engine 201 that configures engine 201 to generate a particular output instruction 206. Such configuration can include specification of various parameters under which engine 201 may automatically determine that a particular currency unavailability condition has occurred. Such configuration could also include an authorization command. For example, engine 201 could be configured to provide an alert to computer 207 based on certain criteria that suggest a particular currency may be unavailable. One or more human users of computer 207 could then review that alert and any underlying data that caused the alert. If the user determines that an unavailability condition has occurred with regard to the currency in question (e.g., that insufficient amounts of the currency are available or are available but under generally uneconomic or otherwise onerous conditions per pre-specified criteria), the user could then send a message authorizing transmission of instruction 206. Alert 204 could also be provided via computer 207. Computer 207 may be the same computer on which engine 201 executes and/or may also house one or more of databases 202 and 203. Alternatively, any or all of engine 201, database 202 and database 203 could execute or reside on computers separate from computer 207, with computer 207 communicating with those separate computers over one or more local and/or wide area networks.

In step 301, engine 201 is initialized with regard to a particular futures contract type (“type 1”). This initialization could occur automatically or in response to a human operator's command (e.g., a command from an operator of computer 207). In the present example, a type 1 contract is a futures contract having currency A as the subject matter, a designated quantity (Q) of which is delivered in return for payment of currency B. In other words, each instance of a type 1 contract will obligate a seller to deliver the specified quantity Q of currency A at a specified delivery date for an agreed amount of currency B to be paid by a buyer. The contract size (quantity Q of currency A to be delivered) may be standard for all type 1 contracts. There may be a limited number of possible delivery dates d1 through dn. For example, all type 1 contracts may specify delivery on the 3rd Wednesday of a month, and the longest allowed term of a type 1 contract may be n−1 months. Because the contract price (i.e., the amount of currency B to be paid for the standardized quantity of currency A) may be negotiated between the buyer and seller for each individual instance of a type 1 contract, the contract price may not be part of the initialization information. However, such information might be received in step 303 as part of updates regarding values of type 1 contracts.

The initialization data for type 1 contracts also designates a particular currency and an additional payment. In the present example, the particular currency is currency A and the additional payment is AP. This need not be the case, however. As but one alternative, a contract type could designate a third currency (e.g., currency C) as the particular currency.

In step 302, engine 201 receives information regarding availability of currency A. This information may be received from database 202, from one or more alerts 204, and/or from other sources. The availability information may provide an estimate of the quantity of currency A available on the world, or in a specified local, market, the current exchange rates for and amount of currency A available from each of multiple sources, interest rates for borrowing currency A, forecasts of availability and/or exchange rates for currency A in upcoming time periods, etc. As with step 301, step 302 could occur automatically or in response to a command resulting from input by a human operator into computer 207. For example, an operator of computer 207 may receive one or more indications from separate sources of potential unavailability or recent exchange rate spikes with regard to currency A. Based on such indications, the operator of computer 207 could provide input causing engine 201 to retrieve currency A information from database 203.

In step 303, engine 201 receives an update from database 202 indicating the volume of type 1 contracts outstanding. For example, this update may indicate the total number of outstanding type 1 contracts scheduled for delivery on each of the next delivery dates throughout the next N months, where N is the longest term type 1 contract available. As indicated above, the update could also include information regarding values of outstanding type 1 contracts, e.g., the contracted amount in each contract that the buyer has agreed to pay for the quantity Q of currency A.

As with steps 301 and 302, updating of engine 201 in step 303 could occur in response to a command resulting from input by a human operator into computer 207. Step 303 could also occur automatically. As one example, engine 201 could be configured to automatically retrieve information regarding outstanding type 1 contracts if there are certain triggers in the currency A data received in step 302. Such triggers could include information indicating events consistent with unavailability of currency A, e.g., receipt of an alert 204 (or receipt of a predetermined number of alerts 204), a rise of the average currency A exchange rate by more than a predetermined percentage of its current value or by more than some other amount, a drop in the estimated worldwide supply of currency A below a certain level, an increase in currency A lending rates beyond a particular level or amount, a news report regarding events in the country issuing currency A, etc. As another example, engine 201 could be configured to periodically download updates from information database 202 regardless of whether there are triggers in the data received in step 302.

In step 304, the information regarding currency A and regarding type 1 contracts is evaluated. Based on that evaluation, a determination is made regarding whether an unavailability condition has occurred with regard to currency A. This determination could be made automatically by engine 201. For example, engine 201 could be configured to compare an estimated amount of currency A available on the world market with the volume of type 1 contracts that will become due in the next month (or in the next several months). If the estimated supply of currency A is less than a predefined multiple of the type 1 contract volume, an unavailability condition could be deemed to occur. As another alternative, an average current exchange (or interest) rate for currency A could be compared to exchange rates in preceding periods. If the current average exchange (or interest) rate exceeds a value calculated from one or more previous period exchange (or interest) rates by a certain amount, an unavailability condition could be declared.

Step 304 could also include a human decision regarding whether an unavailability condition for currency A has occurred. This decision could be based on objective or subjective criteria. As part of this decision process, information regarding type 1 contracts and currency A availability that was received at engine 201 is also received at computer 207. As engine 201 receives information during steps 301-303 in some embodiments, for example, engine 201 may forward that information to computer 207. That forwarded information can then be output by computer 207 and used by one or more persons to determine if an unavailability condition exists.

In some embodiments, engine 201 may automatically receive (or retrieve) information in steps 301-303, but only sends that information to computer 207 under certain circumstances. For example, engine 201 could be configured to transmit a message to computer 207 in response to, and alerting a computer 207 user of, certain events that are consistent with unavailability of currency A. Such events could include receipt of an alert 204 (or receipt of a predetermined number of alerts 204), a rise of the average currency A exchange rate above some level, a rise in the average borrowing or interest rate associated with currency A above some level, a drop in the estimated worldwide or local supply of currency A below a certain level, a news report regarding events in the country issuing currency A, a regulatory measure that otherwise restricts the availability, convertibility or transfer of currency A, etc.

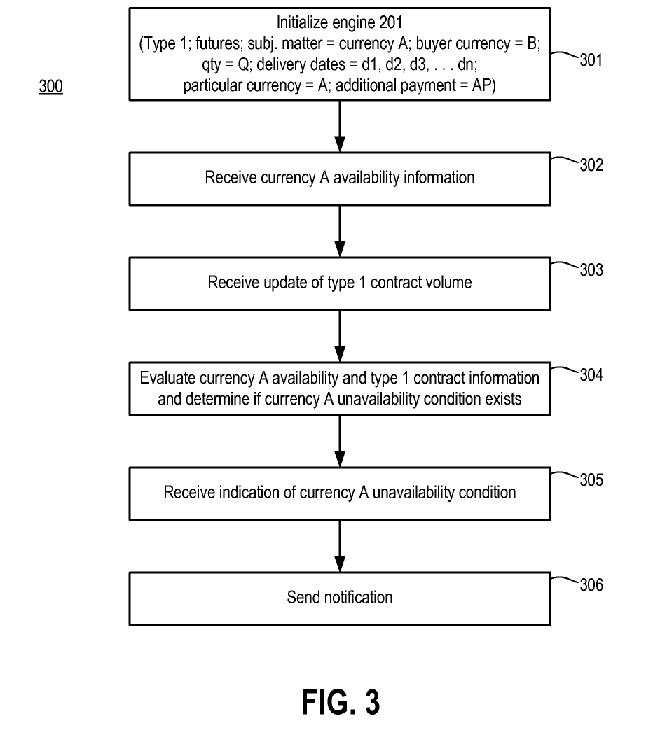

If it is determined in step 304 that a currency A unavailability condition does not exist, the method could conclude. In the example of FIG. 3, however, a currency A unavailability condition is found to exist. Accordingly, in step 305 engine 201 receives an indication of that currency A unavailability condition. If the determination of step 304 was made automatically within engine 201, the indication could be the output of that automatic determination. If the determination in step 304 was made by a human, the indication could be a signal received from computer 207, which signal may be sent as a result of computer 207 receiving an indication from a human user that an unavailability condition exists.

In step 306, engine 201 sends notification 206 to one or more of the elements of exchange computer system 100 and/or otherwise disseminates notification 206 to market participants. The content of notification 206 can be preconfigured or could be determined in some other manner. For example, an operator of computer 207 could provide some or all of the notice 206 content when providing an indication of the currency A unavailability condition to engine 201 in step 305.

The content of notification 206 can vary. Notification 206 could include an instruction that, until further notice, all type 1 contracts may or must be settled after a deferment time period for a payment on the contract, and may further include an additional payment (AP in the present example) to be used to settle the payment. Notification 206 might also indicate that other payments associated with type 1 contracts could be made using equivalent periods of time for deferment and additional payments. In some cases, the deferment period of time may be a specified number of days, such as 14 business days, or may be until the currency A if available.

In some cases, it might be determined in step 304 that a currency A unavailability condition has occurred, but that there is a sufficient supply of currency A to permit some type 1 contract settlements and/or payments to be made using currency A. Accordingly, notification A could further include information indicating a portion of type 1 contract payments for which currency A is to be used and payment made in the time originally required by a contract, and a portion of other type 1 contract payments for which a deferment time period for a payment on the contract along with an additional payment is to be used. An allocation for deferment of contract payments could be implemented in multiple ways. For example, deferment for contract payments might only be authorized for older type 1 contracts with near-term delivery dates. As another example, deferments for contract payments might only be authorized for a randomly selected subset of all type 1 contracts. As yet another example, deferments of contract payments might only be authorized for a portion of payments due under each type 1 contract (e.g., require each type 1 contract to be settled by the particular currency A after deferment of 14 calendar days and 50% by the particular currency A after deferment of 7 calendar days). As but another example, deferment for contract payments might only be authorized for parties holding more than a certain amount of type 1 contracts. In addition, the manner for applying the additional payment may be implemented in multiple ways. For example, the additional payment might an interest payment based upon the specified quantity of the particular currency. As another example, the additional payment might be a default penalty payment. The default penalty payment may be a specific amount and/or may be a particular manner for determining the amount, such as an additional 0.5%. As yet another example, the additional payment might be based upon the type of payment due, whether for daily MTM payments, payment in satisfaction of the final settlement of a cash-settled futures contract, or payment made in satisfaction of a delivery in a futures contract.

For simplicity, embodiments have thus far been described using an example of a single type of futures contract. Other embodiments may operate in connection with more generalized and more complicated circumstances. Instead of a single type of futures contract for currency A, there could be multiple additional types: a type 2 contract requiring delivery of currency A for payment of currency C, a type 3 contract requiring delivery of currency A for payment of currency D, etc. There could also be numerous other types of contracts that designate currency A as a particular currency, but which require delivery of a commodity other than currency A (e.g., a futures contract for an agricultural or industrial commodity that requires cash settlement in currency A). There might also be various options for any of the futures contract types that designate currency A as a particular currency. And of course, all of these other contract and option types might exist in a market where there are a large number of futures contract types that do not designate currency A as particular (and/or that may not implicate currency A in any way).

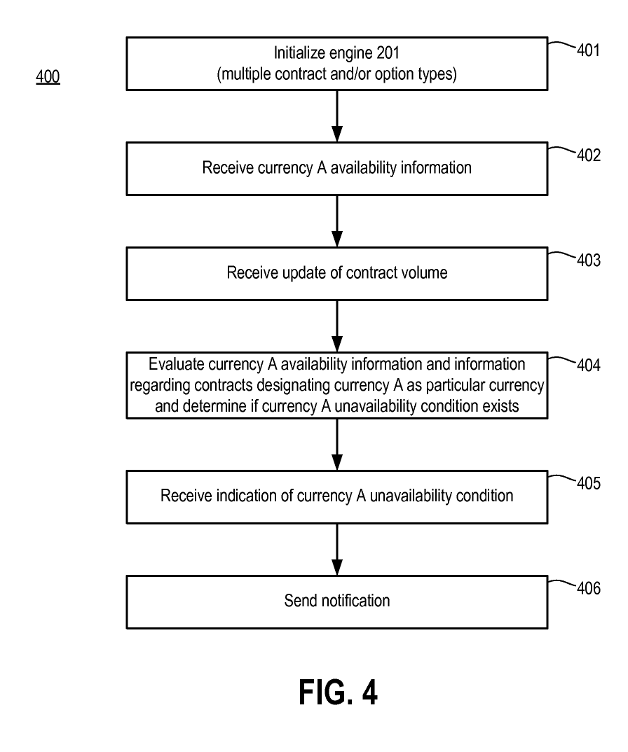

FIG. 4 is a flow chart showing operations in a method 400 according to some embodiments. Method 400 can also be performed using system 200 and is similar to method 300 of FIG. 3. However, method 400 assumes the existence of numerous types of contracts and options that designate currency A as the particular currency, as well as numerous other types of contracts and options that do not designate (and/or do not implicate) currency A.

In step 401, engine 201 is initialized with regard to, and provided with data regarding, the multiple types contracts and options that designate currency A as a particular currency. Although many of those contract types also designate additional payment, some may designate an interest rate as the basis for the additional payment, some may designate a contractual penalty payment as the basis for the additional payment, some may designate an interest rate and a contractual penalty payment as the basis for the additional payment, etc. In step 1, engine 201 is also initialized with regard to (and provided data regarding) numerous other types of contracts and options that do not implicate currency A.

In step 402, engine 201 receives information regarding availability of currency A. During step 402, however, engine 201 might also receive information regarding other currencies. Engine 201 could receive information in step 402 any of the ways described in connection with step 302 of FIG. 3.

In step 403, engine 201 receives one or more updates from database 202 indicating the volume of all types of contracts and options for which currency A is designated as the particular currency. During step 403, however, engine 201 might also receive one or more updates from database 202 indicating the volume for types of contracts and options that do not implicate currency A. Engine 201 could receive updates in step 403 any of the ways described in connection with step 303 of FIG. 3.

In step 404, the information regarding currency A and the information regarding all contracts and options that designate currency A as particular currency contracts is evaluated. Based on that evaluation, a determination is made regarding whether an unavailability condition has occurred with regard to currency A. This determination can be made automatically by engine 201 or with human involvement in ways similar to those described in connection with step 304 of FIG. 3.

In the example of FIG. 4, a currency A unavailability condition is found to exist. Accordingly, in step 405, engine 201 receives an indication of that currency A unavailability condition. This indication can be received in ways similar to those described in connection with step 305 of FIG. 3.

In step 406, engine 201 sends notification 206 to one or more of the elements of exchange computer system 100 and/or otherwise disseminates notification 206 to market participants. The content of notification 206, which can be set in ways similar to those discussed in connection with FIG. 3, can also vary in ways similar to those described in connection with FIG. 3. For example, notification 206 could include an instruction that, until further notice, all type 1 contracts may be settled (and/or other obligations under such contracts paid) after a deferment time period for a payment on the contract, and may further include an additional payment to be used to settle the payment. As another example, notification 206 might also indicate that other payments associated with type 1 contracts could be made using equivalent periods of time for deferment and additional payments.

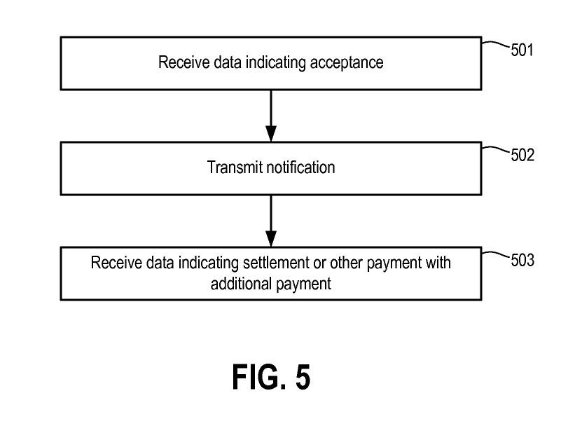

FIG. 5 is a flow chart showing steps that may be performed in connection with a futures contract or other multi-laterally traded and/or cleared contract that designates a particular currency and an additional payment. The steps shown in FIG. 5 could be performed in the system of FIG. 1 as operations resulting from execution of computer-readable instructions. Beginning in step 501, exchange computer system 100 receives data indicating acceptance of an offer (or bid) for a futures contract that designates a particular currency and an additional payment. At a later date, and as shown in step 502, a notification authorizing settlement and additional payment is transmitted. In step 503, data regarding the contract is received, which data indicates that settlement and other payment have been made.

As another more specific example, futures contracts could designate Chinese renminbi or yuan (RMB or CNY) as the particular contractual currency. Historically, RMB (or CNY) has not been freely convertible to other currencies. In response to the increasing global economic significance of the People's Republic of China, however, the People's Bank of China (PBC) has taken steps to liberalize use of RMB in offshore locations such as Hong Kong. An offshore market in RMB, known as the CNH market, is rapidly growing. The PBC also has announced intentions to allow U.S. entities to transact in RMB. Currently, futures in RMB are quoted in “American terms,” or USD per RMB. However, new types of RMB futures contracts could be quoted in “European terms,” or RMB per USD. These new contracts could be cash-settled at the RMB per USD fixing rate published by PBC at 9:15 a.m. (Beijing time) and currently published by Reuters SAEC page opposite “USDCNY=”. Although these new contracts could employ a cash settlement, the contracts could alternately provide for a physical delivery of RMB vs. USD, facilitated through an exchange-designated settlement bank.

Currently, however, onshore RMB is not convertible with other currencies while offshore CNH is limited in its availability or is available for borrowing at uneconomic interest rates or there are regulatory restrictions regarding ownership. Accordingly, these new contract types could, similar to contract types discussed in connection with description of other embodiments, utilize procedures in the event that RMB is not available to support RMB-denominated daily mark-to-market payments, RMB-denominated final mark-to-market payments for cash-settled contracts, or physical delivery of RMB. If circumstances are such that one or more clearing members of an exchange is required to make RMB-denominated payments but is unable to do so because of circumstances beyond that member's control, the exchange may authorize deferment of such required payments for a period of time and an accompany additional payment be calculated. The amount of the additional payment could be determined by a contractual interest rate and/or penalty amount. The deferment period may be for a contractually specified number of days, such as 14 calendar days, or until such time as the particular currency becomes available. The exchange could have sole discretion to impose an additional payment under circumstances that could include illiquidity in the offshore RMB market, inconvertibility of RMB, non-transferability of RMB, etc. One of these new type contracts could include a “standard” sized futures contract (or an option on futures) nominally based on USD 100,000 and quoted in minimum increments of 0.0010 RMB per USD=100 RMB. Another of these new type contracts could include a “micro” sized futures contract (or an option on futures) nominally based on USD 10,000 and quoted in minimum increments of 0.0010 RMB per USD=10 RMB.

Embodiments described herein can be combined with embodiments described in the aforementioned commonly-owned application titled “Modification of Multi-Laterally Traded Contracts Based on Currency Unavailability Condition.”

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that the steps illustrated in the illustrative figures may be performed in other than the recited order, and that one or more steps illustrated may be optional in accordance with aspects of the embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
receiving at a computer data regarding a first payment, denominated in a particular currency, required in satisfaction of contractual obligations of a multi-laterally traded contract, the first payment being a specified quantity of the particular currency at a specified delivery date;
receiving at a computer data indicative of an unavailability of the specified quantity of the particular currency;
receiving at a computer data indicative of a period of time for deferment of the first payment;
receiving at a computer data regarding a second payment based on the received data indicative of the unavailability of the specified quantity of the particular currency and the received data indicative of the period of time for deferment; and
transmitting from a computer a notification authorizing payment of the contractual obligations with the second payment.

2. The method of claim 1, wherein the multi-laterally traded contract is a futures contract.

3. The method of claim 1, wherein the period of time for deferment of the first payment is a contractually specified number of days.

4. The method of claim 1, wherein the period of time for deferment of the first payment is until the specified quantity of the particular currency is available.

5. The method of claim 1, wherein the second payment is an interest payment based upon the specified quantity of the particular currency.

6. The method of claim 1, wherein the second payment is a penalty payment.

7. The method of claim 6, wherein the penalty payment is based upon a determination by a governing body overseeing the multi-laterally traded contract.

8. The method of claim 1, wherein the unavailability is an indication that the particular currency is at least one of: illiquid, inconvertible, and non-transferrable.

9. One or more non-transitory computer-readable medium storing computer executable instructions that, when executed, cause at least one computer to perform operations that include:
receiving data regarding a first payment, denominated in a particular currency, required in satisfaction of contractual obligations of a multi-laterally traded contract, the first payment being a specified quantity of the particular currency at a specified delivery date;
receiving data indicative of an unavailability of the specified quantity of the particular currency;
receiving data indicative of a period of time for deferment of the first payment;
receiving at a computer data regarding a second payment based on the received data indicative of the unavailability of the specified quantity of the particular currency and the received data indicative of the period of time for deferment; and
transmitting a notification authorizing payment of the contractual obligations with the second payment.

10. The one or more non-transitory computer-readable medium of claim 9, wherein the multi-laterally traded contract is a futures contract.

11. The one or more non-transitory computer-readable medium of claim 9, wherein the period of time for deferment of the first payment is a contractually specified number of days.

12. The one or more non-transitory computer-readable medium of claim 9, wherein the period of time for deferment of the first payment is until the specified quantity of the particular currency is available.

13. The one or more non-transitory computer-readable medium of claim 9, wherein the second payment is an interest payment based upon the specified quantity of the particular currency.

14. The one or more non-transitory computer-readable medium of claim 9, wherein the second payment is a penalty payment.

15. The one or more non-transitory computer-readable medium of claim 14, wherein the penalty payment is based upon a determination by a governing body overseeing the multi-laterally traded contract.

16. The one or more non-transitory computer-readable medium of claim 9, wherein the unavailability is an indication that the particular currency is at least one of: illiquid, inconvertible, and non-transferrable.

17. An apparatus comprising:
at least one processor; and
at least one memory having stored therein computer executable instructions, that when executed by the at least one processor, cause the apparatus to perform a method of:
receiving data regarding a first payment, denominated in a particular currency, required in satisfaction of contractual obligations of a multi-laterally traded contract, the first payment being a specified quantity of the particular currency at a specified delivery date;
receiving data indicative of an unavailability of the specified quantity of the particular currency;
receiving data indicative of a period of time for deferment of the first payment;
receiving at a computer data regarding a second payment based on the received data indicative of the unavailability of the specified quantity of the particular currency and the received data indicative of the period of time for deferment; and
transmitting a notification authorizing payment of the contractual obligations with the second payment.

18. The apparatus of claim 17, wherein the multi-laterally traded contract is a futures contract.

19. The apparatus of claim 17, wherein the period of time for deferment of the first payment is one of: a contractually specified number of days or until the specified quantity of the particular currency is available.

20. The apparatus of claim 17, wherein the second payment is one of: an interest payment based upon the specified quantity of the particular currency or a penalty payment.
